(19) United States
(12) Patent Application Publication
(10) Pub. No.: US 2026/0141453 A1
(43) Pub. Date: May 21, 2026

(54) CONTRIBUTION INCENTIVES WITH INTERACITVE MEDIA

(71) Applicant: DreamCatcher Retirement, LLC, Bloomington, MN (US)

(72) Inventors: Ronald Matz, Bloomington, MN (US); Ahi Bennuri, St. Paul, MN (US)

(21) Appl. No.: 19/394,159

(22) Filed: Nov. 19, 2025

Related U.S. Application Data
(60) Provisional application No. 63/722,426, filed on Nov. 19, 2024.

(51) Int. Cl. G06Q 40/06

(52) U.S. Cl. CPC G06Q 40/066; G06Q 40/064

(57) ABSTRACT

The present disclosure relates to providing contribution incentives to incentivize contributions by a user to a user financial account. In one aspect, a method includes receiving input credentials associated with a user financial account, linking the user financial account with a user account, collecting user information from the user financial account including a planned retirement age, determining a user interactive media to provide to the user device based on the user information, providing interactive media to the user device, and receiving interaction data associated the interactive media. The method further includes determining a suggested payment amount based on the user information and the metadata. The method also includes providing the suggested payment amount to the user device.

### BACKGROUND

Many individuals, particularly in the United States, have not saved adequately to fund their future retirement needs. They often do not realize this situation in time to do enough about it until it is too late and are forced to delay their retirement entirely. The present contribution matches that employers often provide through their 401(k) plans do not encourage workers to change their behavior to build a retirement ready workforce.

### SUMMARY

This disclosure is generally directed to providing contribution incentives for users to contribute to retirement accounts using interactive media. Specifically, the systems and methods of this disclosure are designed to employ behavioral incentives to save more of workers'paychecks in their retirement plans at an earlier age.

In one aspect, a method includes receiving, from a user device, input credentials associated with a user financial account, linking the user financial account with a user account, collecting user information from the user account including a planned retirement age, determining interactive media to provide to the user device based on the user information, and providing interactive media to the user device. The user device is caused to display the interactive media and record a length of time the interactive media receives input. The method further includes receiving, from the user device, interaction data associated the interactive media. The interaction data includes the length of time the user device received input associated with the interactive media. The method further includes determining a suggested payment amount based on the user information, metadata, and the length of time the user device received input associated with the interactive media and providing the suggested payment amount to the user device. Providing the suggested payment amount includes causing the user device to display a progress of the user account towards a goal based on the planned retirement age.

In an additional aspect, a system, includes one or more processors and a non-transitory computer-readable storage medium encoding instructions which, when executed by the one or more processors, causes the system to receive, from a user device, input credentials associated with a user financial account, link the user financial account with a user account, collect user information from the user account including a planned retirement age, determine interactive media to provide to the user device based on the user information, and provide the interactive media to the user device. The user device is caused to display the interactive media and record a length of time the interactive media receives input. The instructions further cause the system to receive, from the user device, interaction data associated the interactive media. The interaction data includes the length of time the user device received input associated with the interactive media. The instructions further cause the system to determine a suggested payment amount based on the user information, metadata, and the length of time the user device received input associated with the interactive media and provide the suggested payment amount to the user device. To provide the suggested payment amount includes to cause the user device to display a progress of the user account towards a goal based on the planned retirement age.

In another aspect, a non-transitory computer-readable medium has stored thereon one or more sequences of instructions for causing one or more processors to perform receiving, from a user device, input credentials associated with a user financial account; linking the user financial account with a user account; collecting user information from the user account including a planned retirement age; determining interactive media to provide to the user device based on the user information; and providing interactive media to the user device. The user device is caused to display the interactive media and record a length of time the interactive media receives input. The instructions further cause the one or more processors to perform receiving, from the user device, interaction data associated the interactive media. The interaction data includes the length of time the user device received input associated with the interactive media. The instructions further cause the one or more processors to perform determining a suggested payment amount based on the user information, metadata, and the length of time the user device received input associated with the interactive media and providing the suggested payment amount to the user device. Providing the suggested payment amount includes causing the user device to display a progress of the user account towards a goal based on the planned retirement age.

### BRIEF DESCRIPTION OF THE DRAWINGS

FIG. 1 illustrates the main components of a contribution incentives system.

FIG. 2 illustrates a flowchart showing the application logic for the contribution incentives system and its interaction with the API and user interface.

FIG. 3 illustrates a flow chart to show how face aging is implemented in the context of the contribution incentives system.

FIG. 4 illustrates a list of all the game module components.

FIG. 5 illustrates the web application structure.

FIG. 6 illustrates a sample domain model.

FIG. 7 illustrates an example web API used by the contribution incentives system.

FIG. 8 shows an example user interface displayed by a user computing device that includes a home screen.

FIG. 9 shows an example user interface displayed by the user computing device that includes challenges associated with the user account.

FIG. 10 shows an example user interface displayed by the user computing device that includes game options that can be selected.

FIG. 11 shows an example user interface displayed by the user computing device that includes goals associated with the user account.

FIG. 12 shows an example user interface displayed by the user computing device that includes a leaderboard of one or more user accounts.

FIG. 13 shows example physical components of the contribution incentives system of FIG. 1.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Many individuals seek retirement from their full-time careers, but they lack the necessary tools to achieve their goals. No current devices or systems provide an application that encourages engagement or incentives to increase contributions to an individual's account.

The present disclosure describes a contribution incentives system for increasing contributions to an individual's retirement account. Using interactive media increases engagement and helps users to ensure they are on-track to retire by their desired age. Further, the contribution incentives system automatically calculates suggested payment for continued interaction with the system based on a goal date or age for retirement associated with a user account. The determined amount may also be based on metadata associated with interaction data received from a user device. Using this metadata enables accurate determination of suggested payment amounts that have an increased probability of receiving a contribution to a user financial account.

In addition, the contribution incentives system may determine an interactive media based on a user profile. A user account may include preferences for preferred interactive media. In some embodiments, the interactive media receives, from a user device, a selection of interactive media that is then provided to the user device. In some embodiments, the contribution incentives system may prevent further interaction with the interactive media until the suggested payment amount is deposited into the user financial account. The deposited amount may match an indicated rate to reach a set financial goal, such as retirement. In some embodiments, the contribution incentives system increases the status associated with a user account. The status may increase based on an amount of time of interaction with the interactive media or an amount deposited into the retirement account.

The present disclosure provides significant technical advantages by integrating multiple APIs and data sources in real-time to deliver a seamless user experience. Unlike merely outlining a concept, the described system and methods implement a concrete technical solution by dynamically determining the user's game state, querying for available upgrades, and managing user interactions through a robust application logic flow. The contribution incentives system leverages secure API calls to external databases and service providers, ensuring that user data is accurately retrieved and processed. This technical implementation not only streamlines the user experience but also enhances system efficiency by automating decision-making processes that would otherwise require manual intervention. So, the invention is a practical application, realized through specific technological systems that improve the functioning of the gaming and incentives platform.

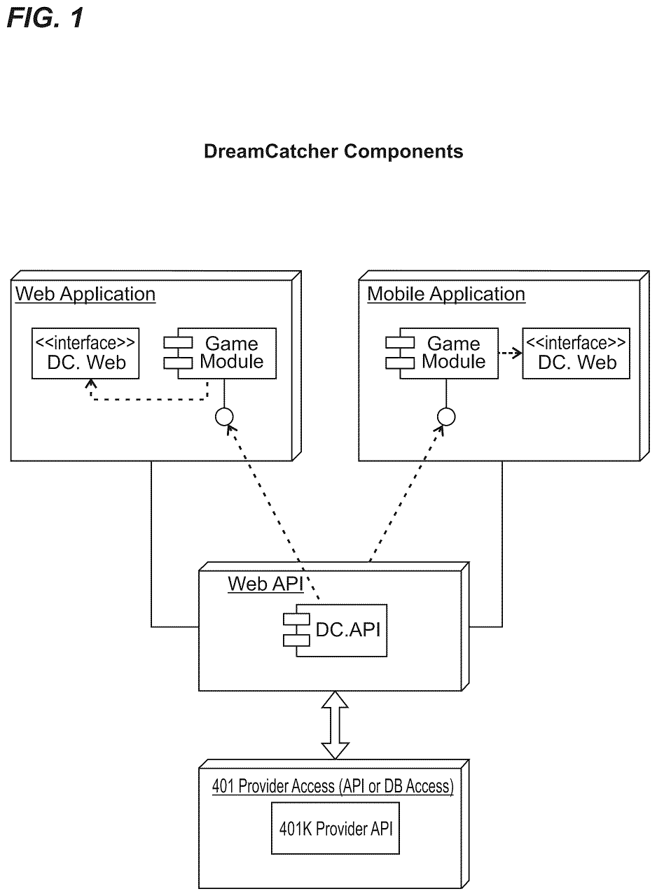

FIG. 1 illustrates components of an example contribution incentives system. It is comprised of a web application, a mobile application, and a web application programming interface (API) that sits on top of either a database that is provided by 401(k) provider, or an API that is also provided by a 401(k) provider. The web application is used to provide users with information on how to use the system, along with an interface to personalize the system. It is also the user interface that will collect user information and provide access to all the features in the contribution incentives system designed to keep the user engaged with the application games, and visualizations of the interactive media systems.

The mobile application will provide identical functionality to the web application, where users can access mobile specific content for which they do not need a full desktop computer. The API is the application programming interface that will be used to access data and business logic stored on the servers and separate from the user interface. The 401(k) provider API or database (DB) will be implementation specific and can vary based on our potential users. This component is provided here for illustrating the concept of where in the application architecture user retirement data is accessed.

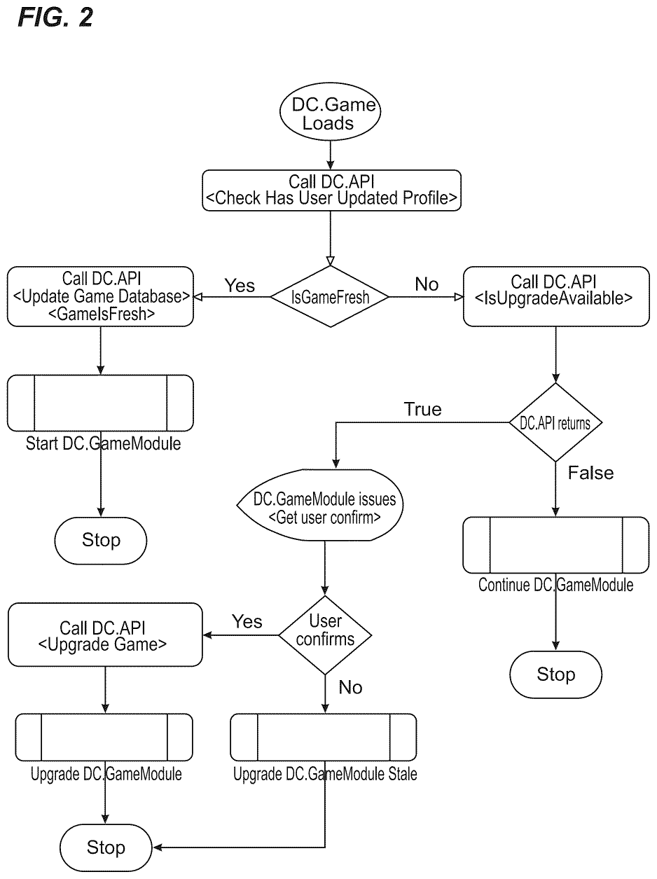

FIG. 2 illustrates a flowchart illustrating the application logic for the contribution incentives system and its interaction with the API and user interface which could either be the web application, or the mobile application. It starts when a game is loaded in the user interface. The contribution incentives system API mentioned in FIG. 1 is called to determine if the user has started a fresh game, or if it is a continuation of a previous game. If the game is fresh, the game module is started, and the game module application logic kicks in, and this would end the current application logic flow. If the game is not fresh, the API in FIG. 1 is called to determine if there are any upgrades available for the user to take advantage of. If no upgrades are available, the game module execution continues bringing this logic flow to an end. If an upgrade is available, the user is asked for confirmation to upgrade. If the user confirms, (different application flow) the contribution incentives system receives a signal that will allow for the user's gaming system to be upgraded and this logic flow ends. If not, the game is updated that the user declined to upgrade, and the flow of logic stops.

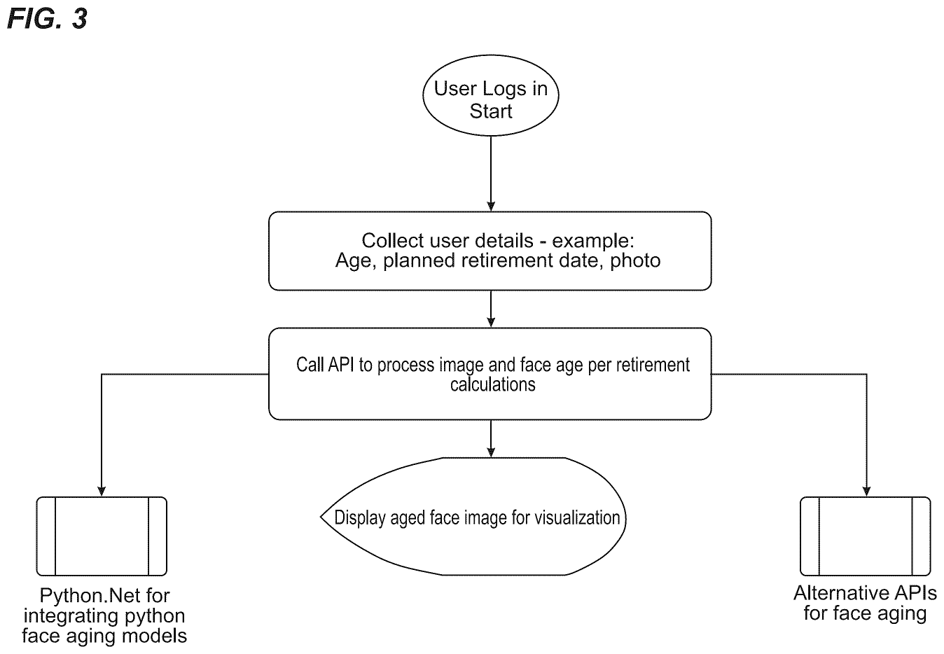

FIG. 3 illustrates a flow chart to show how face aging is implemented in the context of the contribution incentives system. When the user logs in, this flow starts. The user information is collected from the 401(k) provider's API/DB including age, planned retirement date, and a photo. The contribution incentives system may collect user information through a user survey. Questions such as the user's plan for retirement are asked and answers are collected. The contribution incentives system also asks for a user's photograph or access to the existing user photo after ensuring proper permissions are obtained and after indicating that the contribution incentives system helps the user visualize their future self. Once the contribution incentives system has all the necessary permissions, the contribution incentives system proceeds to call the face aging API. The output of this API is the path to another image that will show how the user might potentially look when older. The contribution incentives system then displays the aged face image for visualization.

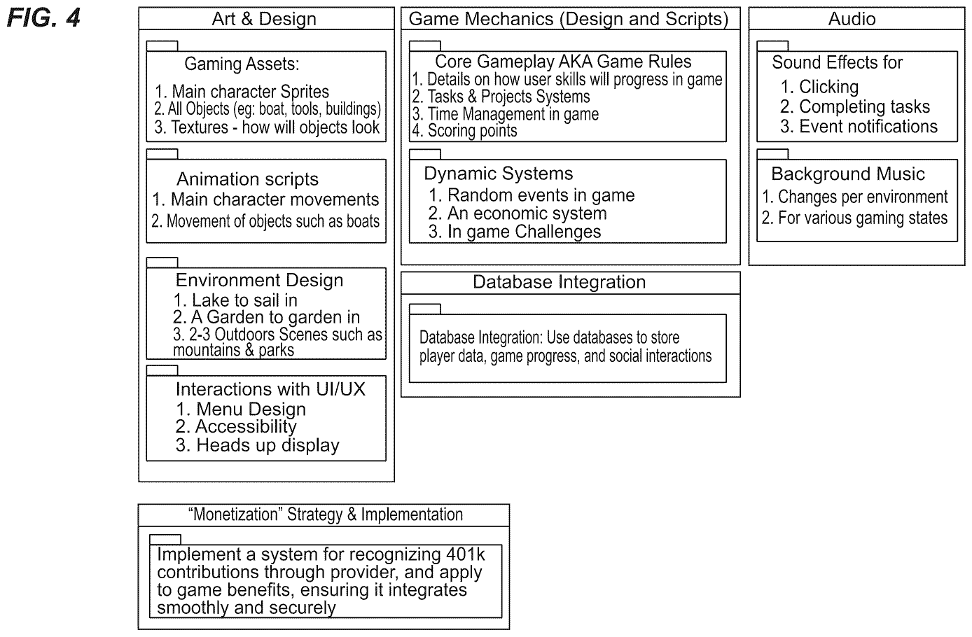

FIG. 4 illustrates a list of all the game module components. It discusses how each game will be designed and what considerations will be taken into account. Notably, some mini game will also feature a dynamic system to keep the user engaged, and a strategy that will enable the contribution incentives system to encourage users to buy into an upgrade that will help users in-game as well as their 401(k) goals. The game module design provides an overview of elements that are created for the game that is developed. Each game module is represented separately in the shown categories.

For example, the contribution incentives system may include an art & design category module. The art & design category module includes gaming an assets module, an animation script module, and an environment design module and an interaction with a user interface/user experience (UI/UX) module. In some examples, the assets module includes: main character sprites, all objects (e.g., boat, tools, buildings), and textures (how will objects look). The animation script module includes: main character movements, movement or objects such as boats. The environment design module includes a lake to sail in, a garden to garden in, and outdoors scenes such as mountains and parks. The interaction with UI/UX module includes menu design, accessibility, and heads up display. The art & design category module relates to assets that make up visual elements including the menus with which the user interacts.

The contribution incentives system may also include a game mechanics category module. The game mechanics category module includes a core gameplay (or also called “game rules”) module and a dynamic systems module. In some examples, the core gameplay module includes details on how user skills will progress in game, tasks and projects systems, time management in the game, and scoring points. The game mechanics category covers details on what needs to be developed in order for a gaming experience to be implemented. For example, the gaming experience may include how characters in a game move and interact with the items in the game.

The contribution incentives system may also include an audio category module. The audio category module includes a sound effects module and a background music module. In some examples, the sound effects module includes clicking, completing tasks, and event notifications. The background music module includes changes per environment and various gaming states. The audio category module covers assets needed for an immersive gaming experience related to sound that is output by a user device related to the game.

The shown logical components of the contribution incentives system can be used to implement the games that are provided to a user device. For example, a list of images used to animate a main character moving from left to right as well as right to left, may be used as a sprite. Further, the listed gaming modules can be used to implement a boat that the main character sails. The contribution incentives system is also configured to implement environments that include components such as a lake in which the implemented boat is sailed.

The contribution incentives system may also include a database integration module and a monetization strategy & implementation module. In some examples, the database integration module includes uses of databases to store player data, game progress, and social interactions. In some examples the monetization strategy and implementation module includes implementing a system for recognizing 401k contributions through a provider, and applying to game benefits, ensuring it integrates smoothly and securely.

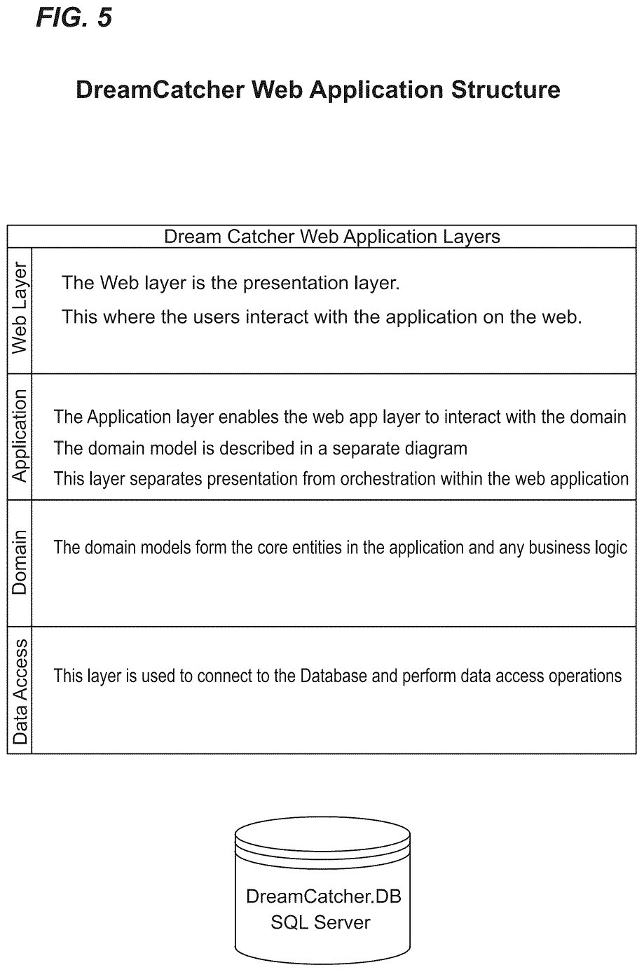

FIG. 5. illustrates the web application structure. It consists of various layers including a UI/Web layer and an application layer which is presentation logic. The web application structure also includes a domain layer which is all of the business entities that are listed in a separate domain model and a data access layer which is concerned with saving/retrieving data from the database.

In the shown embodiment, the web application structure includes a web layer, an application layer, a domain layer, and a data access layer. The web layer is a presentation layer where the user interacts with the application associated with the contribution incentives system on the web. The application layer interacts with the domain layer and separates presentation from orchestration within the web application. The domain models form core entities in the application and any used business logic. The data access layer connects to a contribution incentives database and performs data access operations.

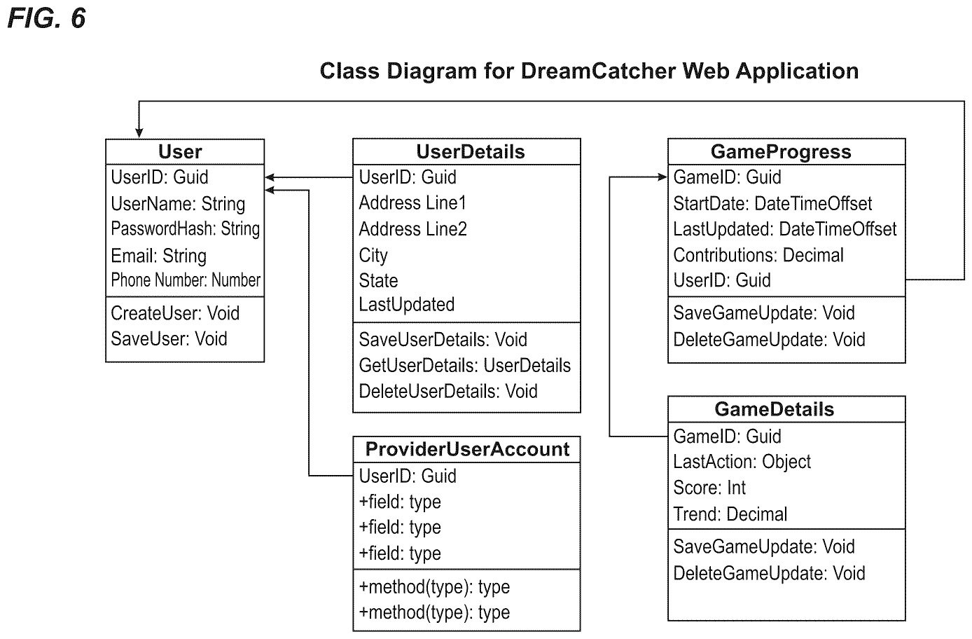

FIG. 6 illustrates a sample domain model. The shown data fields include a user, user details, game progress, provider user account, and game details. Each field has associated data fields, which data can be entered and stored. For example, a user can have an associated user ID, username, password Hash, email, and phone number. In some embodiments, the web application of the system includes additional data fields along with different or additional data entries. Likewise, user details may include a user ID, address, city, state, and last updated values. Provider user account may include a user ID and a plurality of fields. Game progress may include a game ID, a start date, a last updated date, and a contributions amount. Game details may include a game ID, a last action, a score, and a trend.

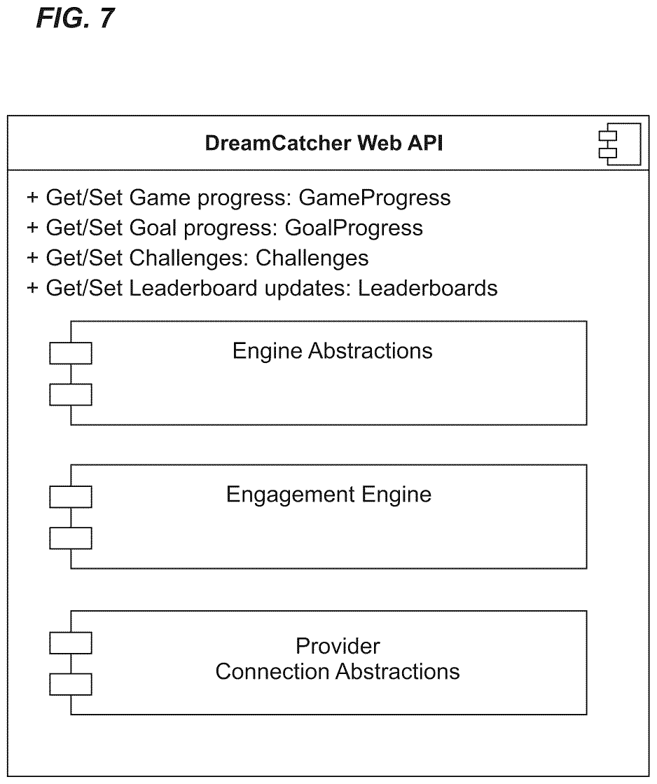

FIG. 7 illustrates an example web API used by the contribution incentives system. In this embodiment, the web API includes an abstractions engine, an engagement engine, and a provider connection abstractions engine. The listed modules ensure that the contribution incentives system can evolve without unnecessary changes to the underlying architecture of the system that cost time and resources to change.

The abstractions engine consistently invokes the underlying methods of the platform to get or set the users'retirement savings status. The engagement engine monitors engagement of users with the contribution incentives system. The provider connection abstractions engine connects to any third-party 401(k) provider that can at any time be substituted without breaking the underlying layers previously discussed.

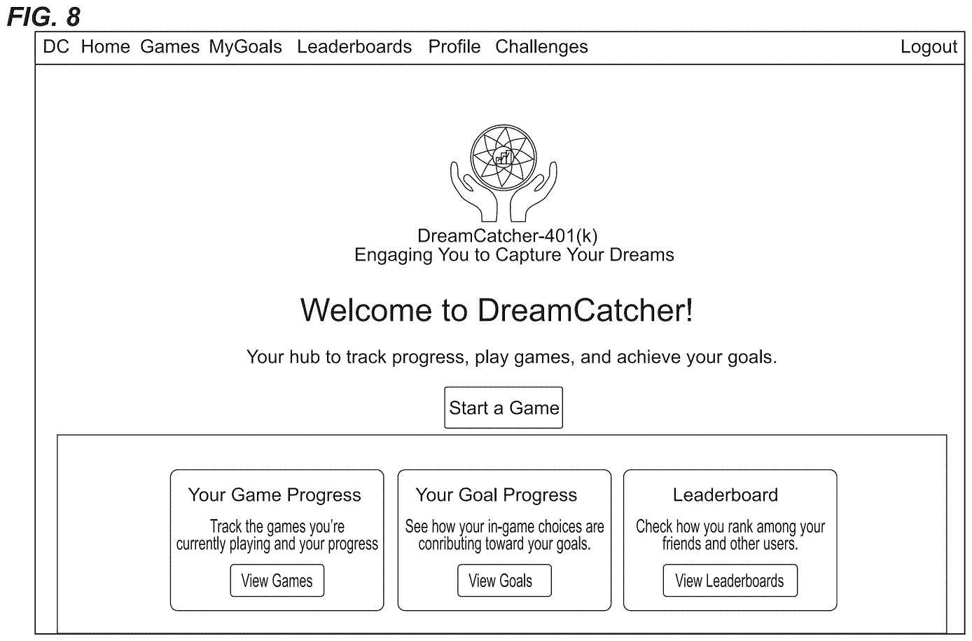

FIG. 8 shows an example user interface displayed by a user computing device that includes a home screen. This user interface shows a home screen for an application that is accessed through a user computing device and provided by the contribution incentives system.

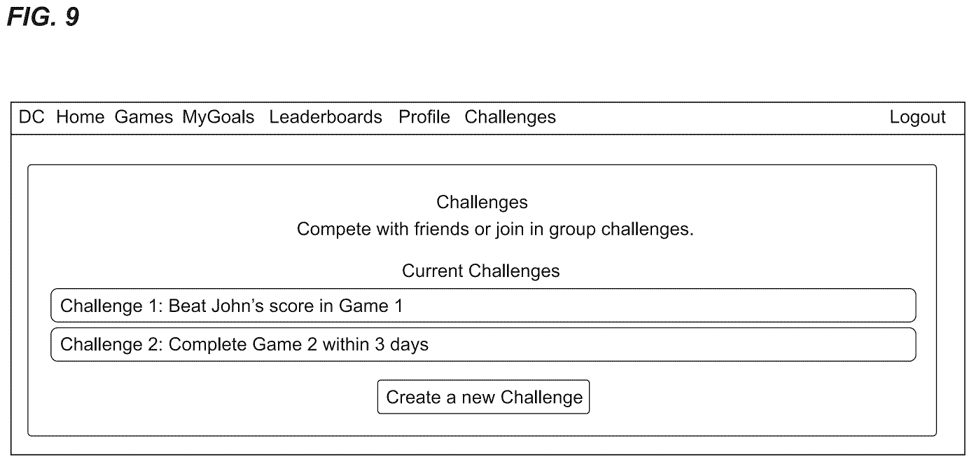

FIG. 9 shows an example user interface displayed by the user computing device that includes challenges associated with the user account.

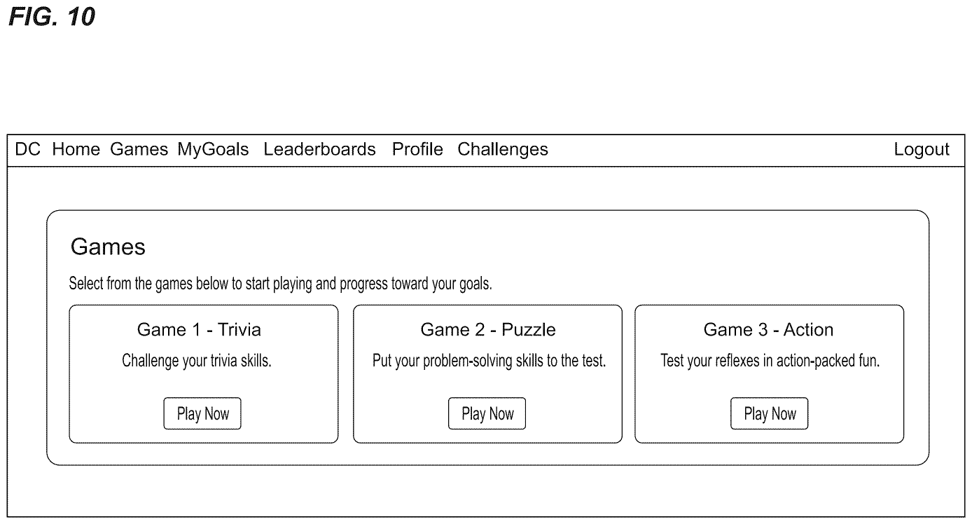

FIG. 10 shows an example user interface displayed by the user computing device that includes game options that can be selected.

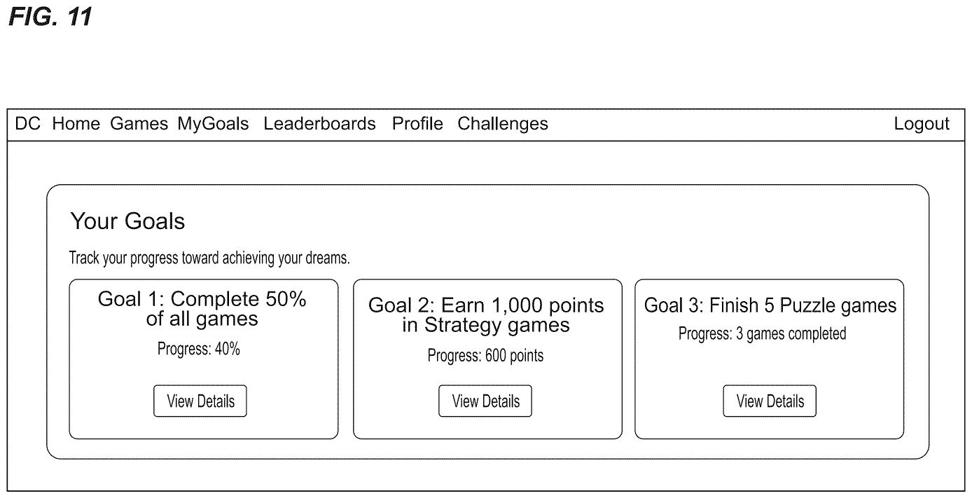

FIG. 11 shows an example user interface displayed by the user computing device that includes goals associated with the user account.

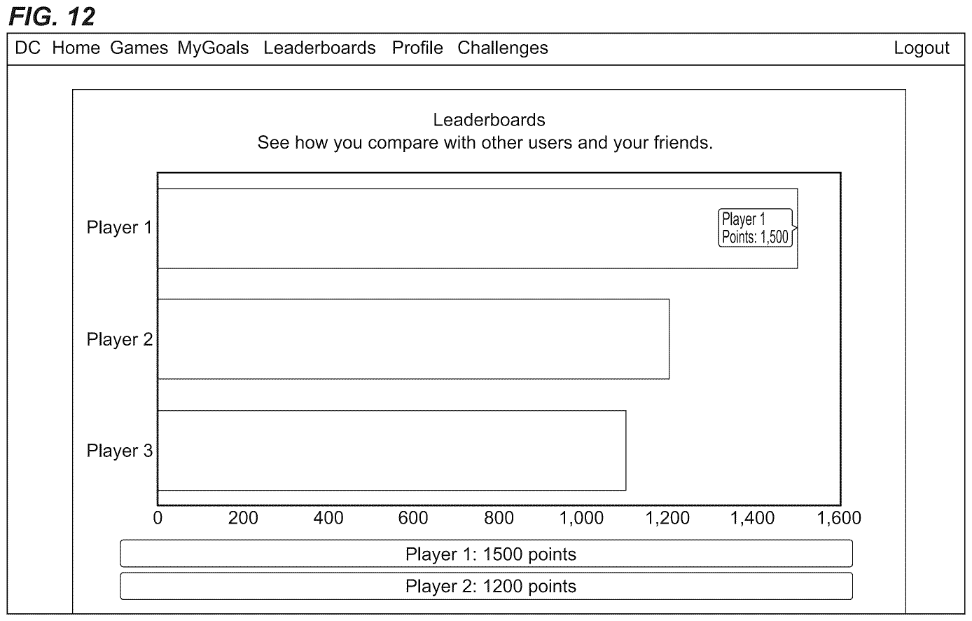

FIG. 12 shows an example user interface displayed by the user computing device that includes a leaderboard of one or more user accounts.

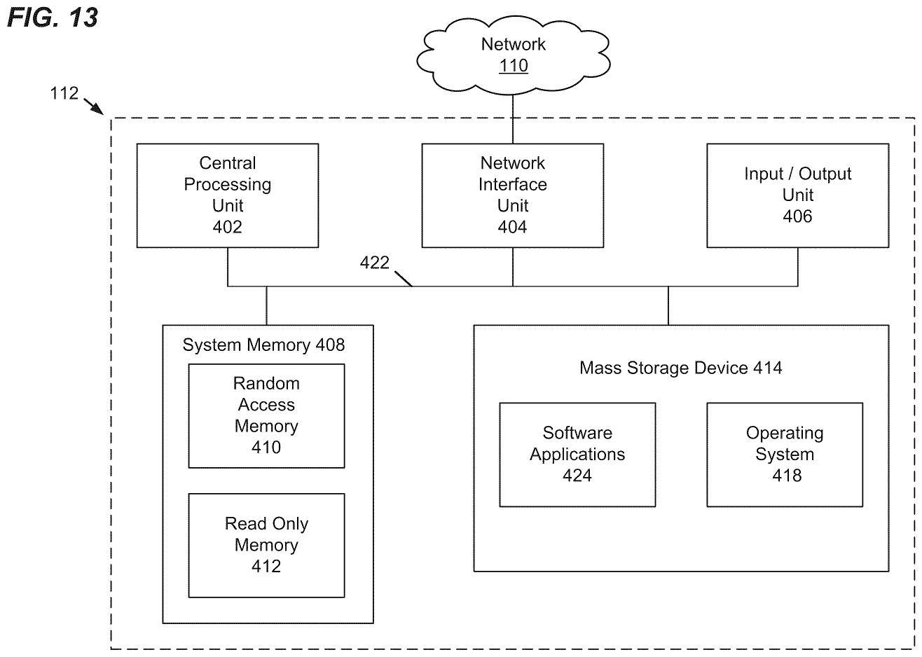

As illustrated in the embodiment of FIG. 13, an example server device 112, which provides the functionality described herein, can include at least one central processing unit (“CPU”) 402, a system memory 408, and a system bus 422 that couples the system memory 408 to the CPU 402. The system memory 408 includes a random-access memory (“RAM”) 410 and a read-only memory (“ROM”) 412. A basic input/output system containing the basic routines that help transfer information between elements within the server device 112, such as during startup, is stored in the ROM 412. The server device 112 further includes a mass storage device 414. The mass storage device 414 can store software instructions and data. A central processing unit, system memory, and mass storage device similar to that shown can also be included in the other computing devices disclosed herein.

The mass storage device 414 is connected to the CPU 402 through a mass storage controller (not shown) connected to the system bus 422. The mass storage device 414 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to a network 110 through a network interface unit 404 connected to the system bus 422. It should be appreciated that the network interface unit 404 may also be utilized to connect to other types of networks and remote computing systems. The server device 112 also includes an input/output controller 406 for receiving and processing input from a number of other devices, including a touch user interface display screen or another type of input device. Similarly, the input/output controller 406 may provide output to a touch user interface display screen or other output devices.

As mentioned briefly above, the mass storage device 414 and the RAM 410 of the server device 112 can store software instructions and data. The software instructions include an operating system 418 suitable for controlling the operation of the server device 112. The mass storage device 414 and/or the RAM 410 also store software instructions and applications 424, that when executed by the CPU 402, cause the server device 112 to provide the functionality of the server device 112 discussed in this document.

In one example, a method includes receiving, from a user device, input credentials associated with a user financial account, linking the user financial account with a user account, collecting user information from the user account including a planned retirement age, determining interactive media to provide to the user device based on the user information, and providing interactive media to the user device. The user device is caused to display the interactive media and record a length of time the interactive media receives input. The method further includes receiving, from the user device, interaction data associated the interactive media. The interaction data includes the length of time the user device received input associated with the interactive media. The method further includes determining a suggested payment amount based on the user information, metadata, and the length of time the user device received input associated with the interactive media and providing the suggested payment amount to the user device. Providing the suggested payment amount includes causing the user device to display a progress of the user account towards a goal based on the planned retirement age.

In some examples, the method further includes preventing further interaction with the interactive media until the suggested payment amount is received or an amount of time has passed. In some examples, the suggested payment amount deposits money within the user financial account at a rate based on the planned retirement age. In some examples, the interactive media is a game, news feed, video, or book. In some examples, the method further includes receiving the suggested payment amount and depositing the suggested payment amount in the user financial account. In some examples, collecting the user information includes using an application programming interface. In some examples, the method further includes increasing a status of the user account based on the interaction data. In some examples, the suggested payment amount is proportional to the length of time the user device received interaction input with the interactive media.

In another example, a system, includes one or more processors and a non-transitory computer-readable storage medium encoding instructions which, when executed by the one or more processors, causes the system to receive, from a user device, input credentials associated with a user financial account, link the user financial account with a user account, collect user information from the user account including a planned retirement age, determine interactive media to provide to the user device based on the user information, and provide the interactive media to the user device. The user device is caused to display the interactive media and record a length of time the interactive media receives input. The instructions further cause the system to receive, from the user device, interaction data associated the interactive media. The interaction data includes the length of time the user device received input associated with the interactive media. The instructions further cause the system to determine a suggested payment amount based on the user information, metadata, and the length of time the user device received input associated with the interactive media and provide the suggested payment amount to the user device. To provide the suggested payment amount includes to cause the user device to display a progress of the user account towards a goal based on the planned retirement age.

In some examples, the instructions further cause the system to prevent further interaction with the interactive media until the suggested payment amount is received or an amount of time has passed. In some examples, the suggested payment amount deposits money within the user financial account at a rate based on the planned retirement age. In some examples, the interactive media is a game, news feed, video, or book. In some examples, the instructions further cause the system to receive the suggested payment amount and deposit the suggested payment amount in the user financial account. In some examples, to collect the user information includes to use an application programming interface. In some examples, the instructions further cause the system to increase a status of the user account based on the interaction data. In some examples, the suggested payment amount is proportional to the length of time the user device received interaction input with the interactive media.

In an additional example, a non-transitory computer-readable medium has stored thereon one or more sequences of instructions for causing one or more processors to perform receiving, from a user device, input credentials associated with a user financial account; linking the user financial account with a user account; collecting user information from the user account including a planned retirement age; determining interactive media to provide to the user device based on the user information; and providing interactive media to the user device. The user device is caused to display the interactive media and record a length of time the interactive media receives input. The instructions further cause the one or more processors to perform receiving, from the user device, interaction data associated the interactive media. The interaction data includes the length of time the user device received input associated with the interactive media. The instructions further cause the one or more processors to perform determining a suggested payment amount based on the user information, metadata, and the length of time the user device received input associated with the interactive media and providing the suggested payment amount to the user device. Providing the suggested payment amount includes causing the user device to display a progress of the user account towards a goal based on the planned retirement age.

In some examples, the one or more processors are further caused to perform preventing further interaction with the interactive media until the suggested payment amount is received or an amount of time has passed. In some examples, the suggested payment amount includes deposits of money within the user financial account at a rate based on the planned retirement age. In some examples, the interactive media is a game, news feed, video, or book.

The various embodiments described above are provided by way of illustration only and should not be construed to limit the claims attached hereto. Those skilled in the art will readily recognize various modifications and changes that may be made without following the example embodiments and applications illustrated and described herein, and without departing from the full scope of the following claims.

What is claimed is:

1. A method comprising:
receiving, from a user device, input credentials associated with a user financial account;
linking the user financial account with a user account;
collecting user information from the user account including a planned retirement age;
determining interactive media to provide to the user device based on the user information;
providing interactive media to the user device to cause the user device to display the interactive media and record a length of time the interactive media receives input;
receiving, from the user device, interaction data associated the interactive media, the interaction data including the length of time the user device received input associated with the interactive media;
determining a suggested payment amount based on the user information, metadata, and the length of time the user device received input associated with the interactive media; and
providing the suggested payment amount to the user device, wherein providing the suggested payment amount includes causing the user device to display a progress of the user account towards a goal based on the planned retirement age.

2. The method of claim 1, further comprising:
preventing further interaction with the interactive media until the suggested payment amount is received or an amount of time has passed.

3. The method of claim 1, wherein the suggested payment amount includes deposits of money within the user financial account at a rate based on the planned retirement age.

4. The method of claim 1, wherein the interactive media is a game, news feed, video, or book.

5. The method of claim 1, further comprising:
receiving the suggested payment amount; and
depositing the suggested payment amount in the user financial account.

6. The method of claim 1, wherein collecting the user information includes using an application programming interface.

7. The method of claim 1, further comprising increasing a status of the user account based on the interaction data.

8. The method of claim 1, wherein the suggested payment amount is proportional to the length of time the user device received interaction input with the interactive media.

9. A system, comprising:
one or more processors; and
a non-transitory computer-readable storage medium encoding instructions which, when executed by the one or more processors, causes the system to:
receive, from a user device, input credentials associated with a user financial account;
link the user financial account with a user account;
collect user information from the user account including a planned retirement age;
determine interactive media to provide to the user device based on the user information;
provide the interactive media to the user device to cause the user device to display the interactive media and record a length of time the interactive media receives input;
receive, from the user device, interaction data associated the interactive media, the interaction data including the length of time the user device received input associated with the interactive media;
determine a suggested payment amount based on the user information, metadata, and the length of time the user device received input associated with the interactive media; and
provide the suggested payment amount to the user device, wherein to provide the suggested payment amount includes to cause the user device to display a progress of the user account towards a goal based on the planned retirement age.

10. The system of claim 9, wherein the instructions further cause the system to:
prevent further interaction with the interactive media until the suggested payment amount is received or an amount of time has passed.

11. The system of claim 9, wherein the suggested payment amount includes deposits of money within the user financial account at a rate based on the planned retirement age.

12. The system of claim 9, wherein the interactive media is a game, news feed, video, or book.

13. The system of claim 9, wherein the instructions further cause the system to:
receive the suggested payment amount; and
deposit the suggested payment amount in the user financial account.

14. The system of claim 9, wherein collect the the user information includes to use an application programming interface.

15. The system of claim 9, wherein the instructions further cause the system to:
increase a status of the user account based on the interaction data.

16. The system of claim 9, wherein the suggested payment amount is proportional to the length of time the user device received interaction input with the interactive media.

17. A non-transitory computer-readable medium having stored thereon one or more sequences of instructions for causing one or more processors to perform:
receiving, from a user device, input credentials associated with a user financial account;
linking the user financial account with a user account;
collecting user information from the user account including a planned retirement age;
determining interactive media to provide to the user device based on the user information;
providing interactive media to the user device to cause the user device to display the interactive media and record a length of time the interactive media receives input;
receiving, from the user device, interaction data associated the interactive media, the interaction data including the length of time the user device received input associated with the interactive media;
determining a suggested payment amount based on the user information, metadata, and the length of time the user device received input associated with the interactive media; and
providing the suggested payment amount to the user device, wherein providing the suggested payment amount includes causing the user device to display a progress of the user account towards a goal based on the planned retirement age.

18. The non-transitory computer-readable medium of claim 17, wherein the one or more processors are further caused to perform:
preventing further interaction with the interactive media until the suggested payment amount is received or an amount of time has passed.

19. The non-transitory computer-readable medium of claim 17, wherein the suggested payment amount includes deposits of money within the user financial account at a rate based on the planned retirement age.

20. The non-transitory computer-readable medium of claim 17, wherein the interactive media is a game, news feed, video, or book.
